(19) United States
(12) Patent Application Publication
(10) Pub. No.: US 2011/0308476 A1
(43) Pub. Date: Dec. 22, 2011

(54) Foldable and portable shelter

(76) Inventor: Jui Yang Chang, Taichung (TW)

(21) Appl. No.: 12/802,986

(22) Filed: Jun. 17, 2010

(51) Int. Cl. A01K 1/03

(52) U.S. Cl. 119/497; 119/499

(57) ABSTRACT

A shelter includes a base member having a bottom wall panel, a rear wall panel and a front wall panel foldably coupled to the bottom wall panel with folding lines, an upper member having a top wall panel and two opposed side wall panels foldably coupled to the top wall panel with folding lines, the side wall panels of the upper member are secured to the bottom wall panel of the base member for forming a three-dimensional structure, the front wall panel and the rear wall panel of the base member are selectively latched to the top wall panel and the side wall panels of the upper member, the base member and the upper member each include a number of air circulation openings, and each include a number of reinforcing curved portions.

### BACKGROUND OF THE INVENTION

1. Field of the Invention

The present invention relates to a foldable and portable shelter, and more particularly to a foldable and portable shelter including a foldable structure foldable to a compact folding or receiving structure for storing and transportation purposes, and including an increasing strength for resisting an increased weight or load and for preventing the shelter from being collapsed or distorted.

2. Description of the Prior Art

Typical foldable and portable shelters comprise a number of wall members or panels, such as a bottom wall, two opposed end walls, two side walls, and a roof member, that are required to be assembled together.

For example, U.S. Pat. No. 3,144,852 to Messeas discloses one of the typical portable knock-down animal housing structures including opposed end walls and side walls clampingly interrelated by tie rod members and lock nuts, for supporting a bottom wall, and a roof member shaped and dimensioned to define a shallow receptacle when the housing structure is disassembled to receive the wall members.

However, it will be complicated to manufacture and assemble the opposed end walls and the side walls and the bottom wall and the roof member together, and it will be difficult to engage tie rod members into and through the wall members, such that the manufacturing and assembling time may be greatly increased.

U.S. Pat. No. 3,866,577 to Mathis discloses another typical prefabricated animal housing comprising side walls having spaced corner lugs at the end thereof which interconnect with front and rear walls which also include spaced corner lugs at the end thereof, and a floor and roof mounted with the side walls and the front and rear walls with lock pins.

However, similarly, it will be complicated to manufacture and assemble the side walls and the front and rear walls and the floor wall and the roof member together, and it will be difficult to engage tie lock pins into and through the wall members, such that the manufacturing and assembling time may be greatly increased.

U.S. Pat. No. 4,006,713 to Hawley, III discloses a further typical collapsible dog house comprising two opposed side walls, a front wall, a rear wall, a floor and roof which are separable components, the side walls are notched and grooved to interfit with the skirts of the floor and roof and also to interfit with the front and rear walls.

However, similarly, it will be complicated to manufacture and assemble the side walls and the front and rear walls and the floor wall and the roof member together, and it will be difficult to engage notches and grooves with the skirts of the floor and roof and to interfit with the front and rear walls, such that the manufacturing and assembling time may be greatly increased.

U.S. Pat. No. 4,256,056 to Sou discloses a still further typical portable case for carrying small animal comprising two opposed side boards, a top board connected at its left and right sides to the respective upper end faces of the left and right side wall boards through the aid of hinged joints, and a bottom board connected to the side wall boards.

However, similarly, it will be complicated to manufacture and assemble the side wall boards and the front and rear wall boards and the floor wall board and the roof board member together, and it will be difficult to engage hinged joints into and through the wall members, such that the manufacturing and assembling time may be greatly increased.

U.S. Pat. No. 4,334,501 to McDaniel et al. discloses a still further typical animal shelter and feed dispenser comprising two opposed side boards, a top board connected to the left and right side wall boards, and a bottom board connected to the side wall boards with post members and clip elements.

However, similarly, it will be complicated to manufacture and assemble the side wall boards and the front and rear wall boards and the floor wall board and the roof board member together, and it will be difficult to engage post members and clip elements with the wall members, such that the manufacturing and assembling time may be greatly increased.

U.S. Pat. No. 4,803,952 to Houser discloses a still further typical portable shelter for carrying small animal comprising a body portion foldable to a rectangular and spatial or three-dimensional structure, a base assembly, a first story assembly, an intermediate assembly, a rear wall assembly, a front wall assembly, and a roof assembly.

However, similarly, it will be complicated to manufacture and assemble the body portion, the base assembly, the first story assembly, the intermediate assembly, the rear wall assembly, the front wall assembly, and the roof assembly together, such that the manufacturing and assembling time for the typical portable shelter may be greatly increased.

The present invention has arisen to mitigate and/or obviate the afore-described disadvantages of the conventional foldable and portable shelters for carrying small animals.

### SUMMARY OF THE INVENTION

The primary objective of the present invention is to provide a foldable and portable shelter including a foldable structure foldable to a compact folding or receiving structure for storing and transportation purposes.

The other objective of the present invention is to provide a foldable and portable shelter including an increasing strength for resisting an increased weight or load and for preventing the shelter from being collapsed or distorted.

In accordance with one aspect of the invention, there is provided a shelter comprising a base member including a bottom wall panel, a rear wall panel foldably coupled to the bottom wall panel with a first folding line, and a front wall panel foldably coupled to the bottom wall panel with a second folding line, an upper member including a top wall panel and two opposed side wall panels each foldably coupled to the top wall panel with a third folding line, the side wall panels are secured to the bottom wall panel of the base member for forming a three-dimensional structure, the base member and the upper member include latch members for selectively latching and locking the front wall panel and the rear wall panel of the base member to the top wall panel and the side wall panels of the upper member, and the base member and the upper member each include a number of openings formed therein for air circulation purposes, and each include a number of curved portions formed therein for reinforcing purposes.

The front wall panel and the rear wall panel of the base member each include three curved portions formed therein, and the top wall panel and the side wall panels of the upper member each include two curved portions formed therein for engaging with the curved portions of the base member.

The base member includes a first latch member provided on each of the curved portions thereof, and the upper member includes a second latch member provided on each of the curved portions thereof for engaging with the first latch member. The first latch member is preferably a female latch member, and the second latch member is preferably a male latch member.

The upper member includes a hand grip provided on the top wall panel. The upper member includes two loops, and a carrying strap having two end couplers for selectively engaging with the loops and for detachably attaching the strap to the shelter. The base member includes a pad disposed on the bottom wall panel.

The openings of the base member are formed in the rear wall panel, the base member includes a window plate slidably attached to the rear wall panel, and the window plate includes a number of orifices formed therein for selectively aligning with the openings of the rear wall panel.

The openings of the base member are formed in the front wall panel, the base member includes a window plate slidably attached to the front wall panel, and the window plate includes a number of orifices formed therein for selectively aligning with the openings of the front wall panel.

The openings of the upper member are formed in one of the side wall panels, the upper member includes a window plate slidably attached to the side wall panel, and the window plate includes a number of apertures formed therein for selectively aligning with the openings of the side wall panel.

The openings of the upper member includes a flange laterally extended from each of the side wall panels for engaging with the bottom wall panel of the base member and for securing to the bottom wall panel of the base member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a front perspective view of a foldable and portable shelter in accordance with the present invention;

FIG. 2 is a rear perspective view of the foldable and portable shelter;

FIG. 3 is a partial exploded view of the foldable and portable shelter;

FIG. 4 is a partial cross sectional view of the foldable and portable shelter taken along lines 4-4 of FIG. 1;

FIG. 5 is a front perspective view similar to FIG. 1, illustrating the operation of the foldable and portable shelter;

FIG. 6 is an enlarged partial perspective view illustrating the operation of the foldable and portable shelter;

FIG. 7 is a partial cross sectional view illustrating the operation of the foldable and portable shelter;

FIG. 8 is a partial front perspective view illustrating the operation of the foldable and portable shelter;

FIG. 9 is a plan schematic view illustrating the operation of the foldable and portable shelter;

FIG. 10 is a plan schematic view illustrating one of the members of the foldable and portable shelter;

FIG. 11 is another plan schematic view illustrating the other member of the foldable and portable shelter;

FIGS. 12, 13 are further plan schematic views illustrating the folding operation of the foldable and portable shelter; and

FIG. 14 is a perspective view illustrating the other arrangement of the foldable and portable shelter.

### DETAILED DESCRIPTION OF THE PREFERRED EMBODIMENT

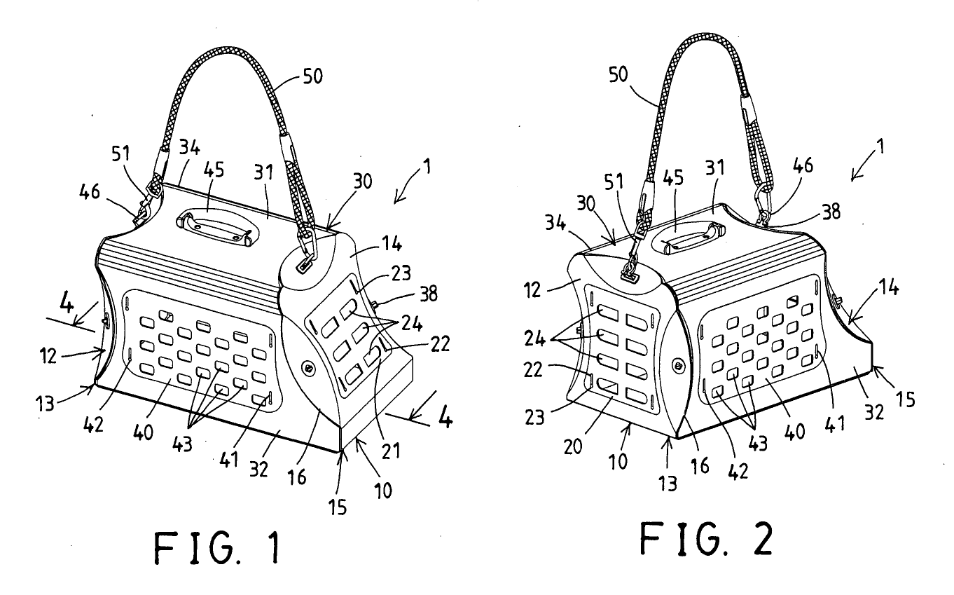

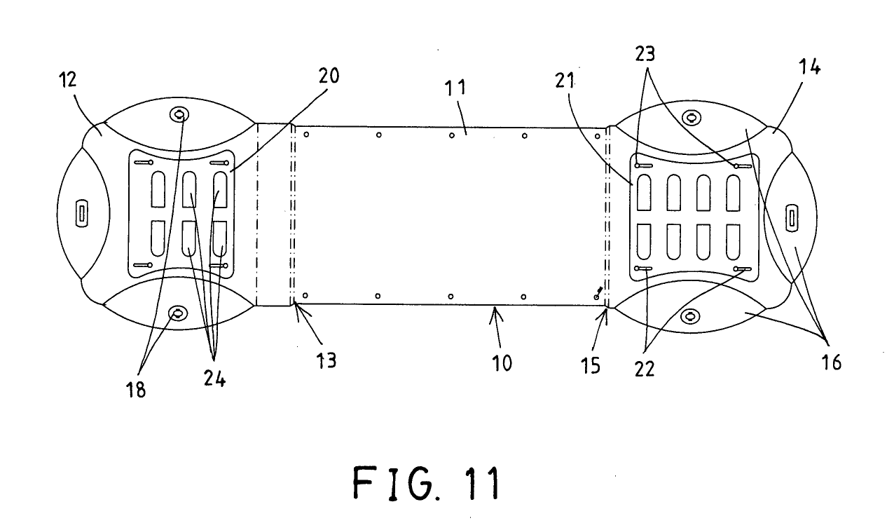

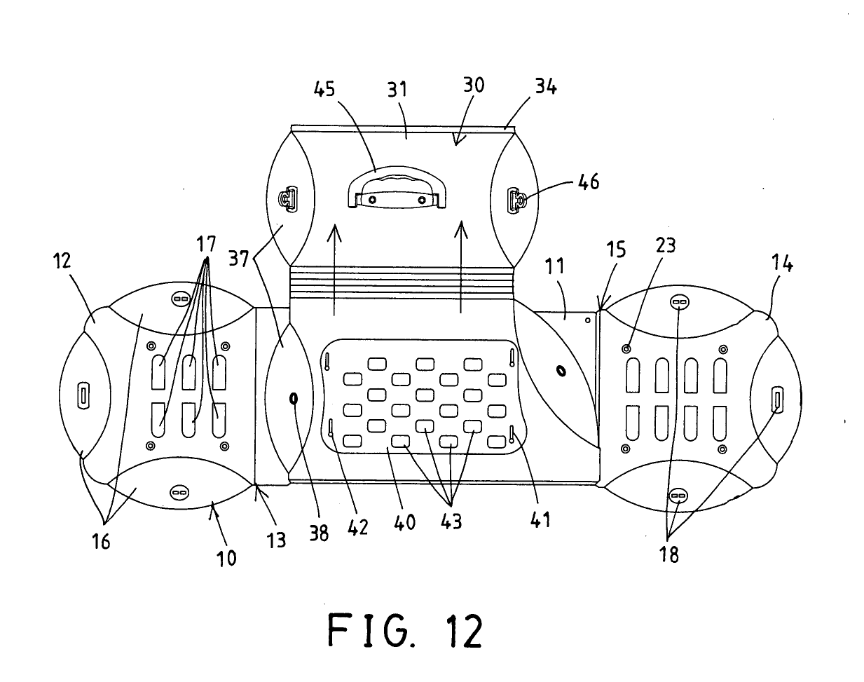

Referring to the drawings, and initially to FIGS. 1-4, a foldable and portable shelter 1 in accordance with the present invention comprises a base member 10 including a bottom wall panel 11, a rear wall panel 12 pivotally or foldably coupled to the bottom wall panel 11 with a hinge line or folding line 13, and a front wall panel 14 pivotally or foldably coupled to the bottom wall panel 11 with another hinge line or folding line 15, the rear wall panel 12 and the front wall panel 14 are foldable and pivotal relative to the bottom wall panel 11 to a U-shaped working position as shown in FIGS. 1-4 and 7-9, or to a planar unfolded or storing position as shown in FIGS. 11-12.

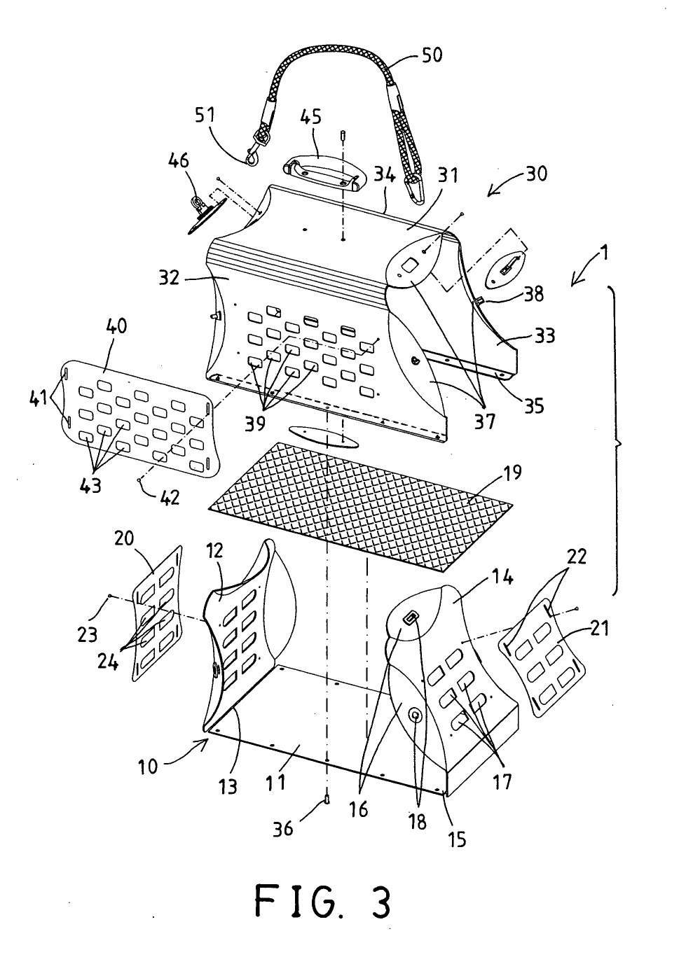

The rear wall panel 12 and the front wall panel 14 each include one or more (such as three) folded or wrinkled or curved portions 16 formed or provided on the outer peripheral portion thereof and curved relative to the rear wall panel 12 and the front wall panel 14 respectively for reinforcing purposes, and each include a number of openings 17 formed therein (FIGS. 3, 5, 8, 12) for air circulation or ventilation purposes, and each include one or more (such as three) latch members 18, such as female latch members 18 formed or provided therein, particularly formed in the curved portions 16 respectively, and a cushion or pad 19 is disposed or attached or mounted on the bottom wall panel 11 and may be easily removed and cleaned for suitably and comfortably supporting the small animal therein.

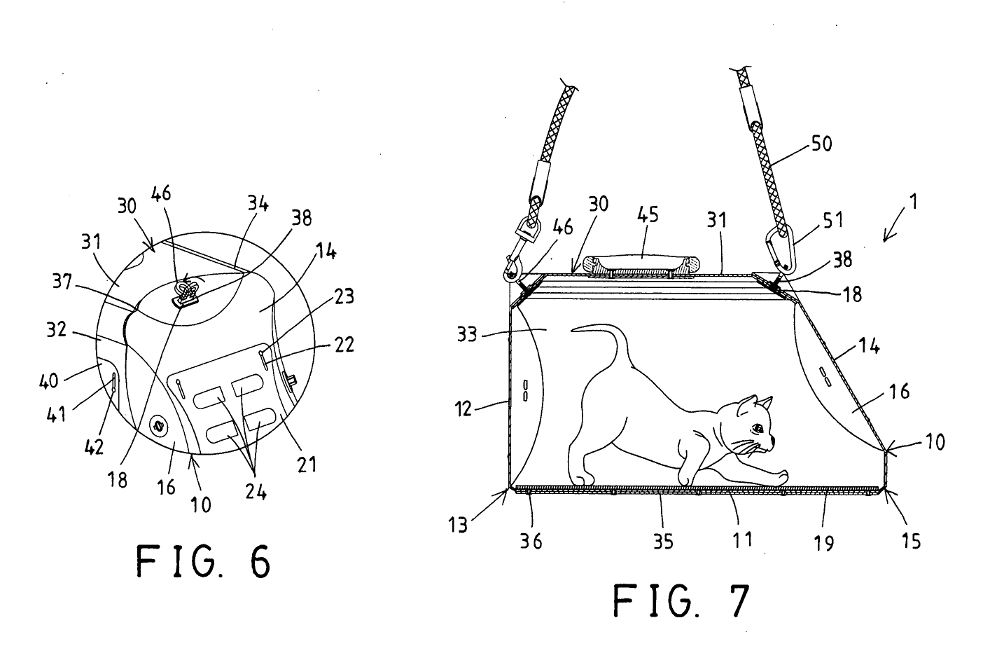

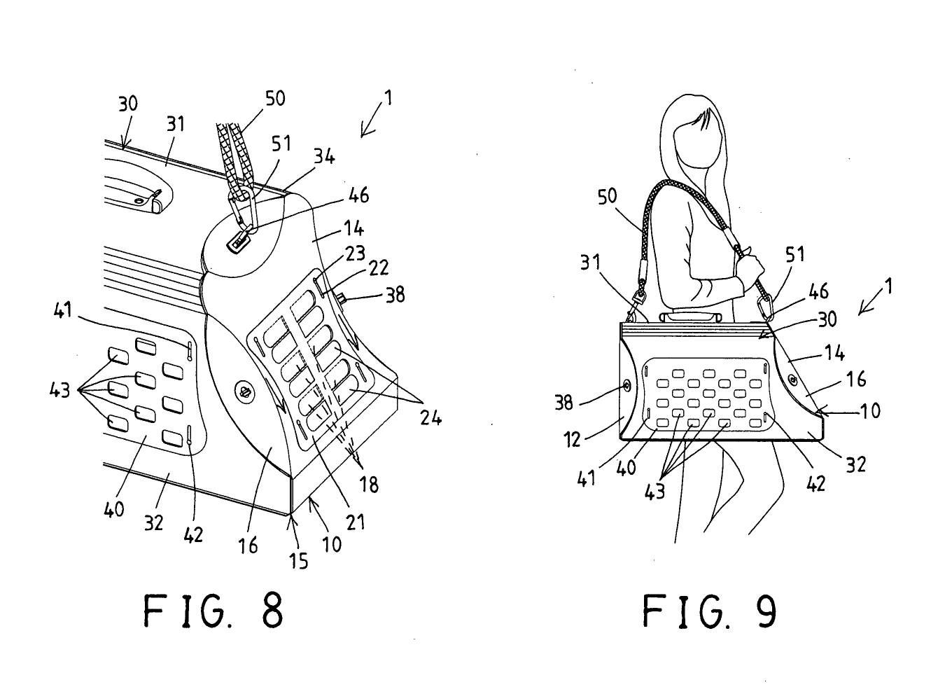

Two window plates 20, 21 each include one or more (such as four) slots 22 formed therein, and one or more (such as four) rivets or fasteners 23 are engaged through the slots 22 of the window plates 20, 21 and mounted or secured to the rear wall panel 12 and the front wall panel 14 respectively for slidably attaching or mounting or securing or coupling the window plates 20, 21 to the rear wall panel 12 and the front wall panel 14 respectively, and the window plates 20, 21 each include a number of orifices 24 formed therein for selectively aligning with the openings 17 of the rear wall panel 12 and the front wall panel 14 respectively (FIGS. 1, 2) and for air circulation or ventilation purposes, or for selectively offset the openings 17 of the rear wall panel 12 and the front wall panel 14 (FIGS. 6, 8) and for selectively blocking or sealing the openings 17 of the rear wall panel 12 and the front wall panel 14 respectively.

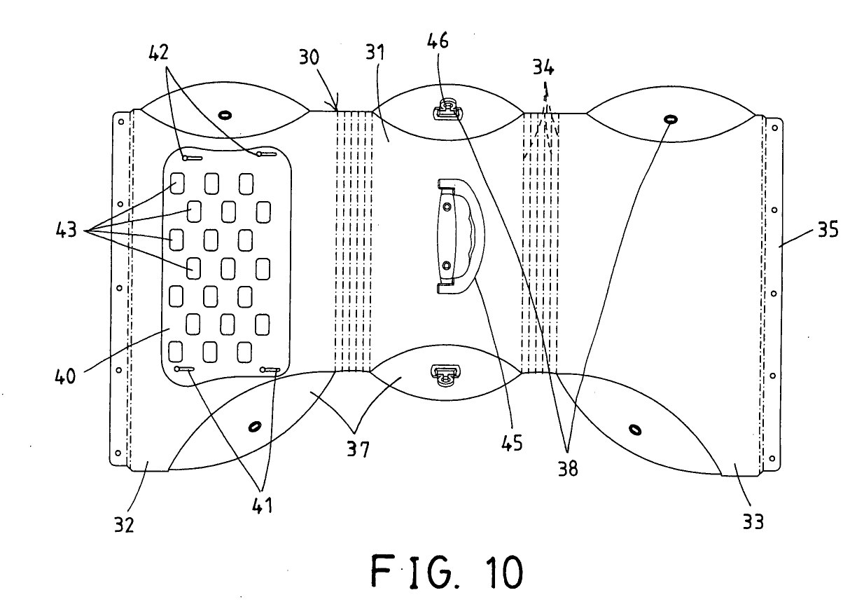

The portable shelter 1 further comprises an upper member 30 including a top wall panel 31 and two opposed side wall panels 32, 33 each pivotally or foldably coupled to the top wall panel 31 with a curved or rounded portion or hinge line or folding line 34, and foldable and pivotal relative to the top wall panel 31 to a U-shaped working position as shown in FIGS. 1-9, or to a planar unfolded or storing position as shown in FIG. 10. The side wall panels 32, 33 each include a flange 35 folded or extended laterally and inwardly from the bottom portion thereof (FIGS. 3, 4, 7, 10) for engaging with the bottom wall panel 11 of the base member 10 and for securing to the bottom wall panel 11 of the base member 10 with rivets or fasteners 36 (FIGS. 3, 4, 7).

The top wall panel 31 and the side wall panels 32, 33 each include one or more (such as two) folded or wrinkled or curved portions 37 formed or provided on the outer peripheral portion thereof (FIGS. 3, 5, 10) and curved relative to the wall panels 31-33 respectively for reinforcing purposes, and for engaging with the curved portions 16 of the base member 10 respectively, and each include one or more (such as two) latch members 38, such as male latch members 38 formed or provided thereon, particularly formed on the curved portions 37 respectively for engaging with the female latch members 18 of the base member 10 respectively, and for selectively locking or latching the rear wall panel 12 and the front wall panel 14 to the wall panels 31-33 of the upper member 30, and for stably receiving the small animal in the portable shelter 1.

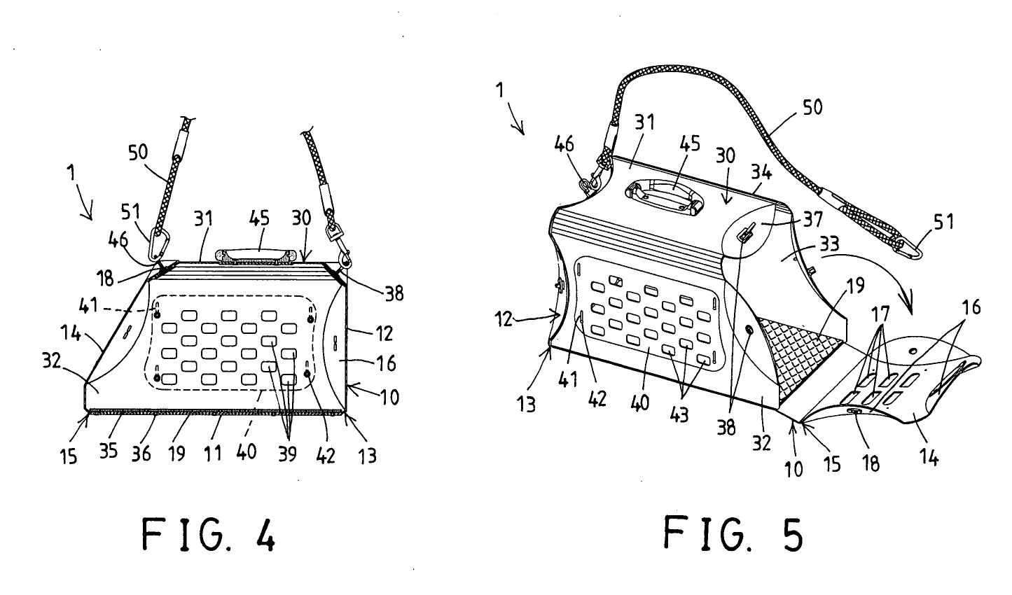

One or both of the side wall panels 32, 33 each include a number of openings 39 formed therein (FIGS. 3, 4) for air circulation or ventilation purposes, and another window plate 40 includes one or more (such as four) slots 41 formed therein, and one or more (such as four) rivets or fasteners 42 are engaged through the slots 41 of the window plate 40 and mounted or secured to the side wall panel 32 for slidably attaching or mounting or securing or coupling the window plate 40 to the side wall panel 32, and the window plate 40 includes a number of apertures 43 formed therein for selectively aligning with the openings 39 of the side wall panel 32 (FIGS. 1, 2) and for air circulation or ventilation purposes, or for selectively offset the openings 39 of the side wall panel 32 and for selectively blocking or sealing the openings 39 of the side wall panel 32.

The portable shelter 1 further includes a hand grip 45 formed or provided on the top wall panel 31 of the upper member 30 for allowing the shelter 1 to be easily carried with the user, and further includes two rings or loops 46 attached to the latch members 38 of the top wall panel 31 of the upper member 30, and a carrying belt or strap 50 includes two end clips or locks or fasteners or couplers 51 for selectively engaging with the loops 46 and for detachably attaching or mounting or securing or coupling the strap 50 to the shelter 1 and for allowing the shelter 1 to be easily carried with the user (FIG. 9).

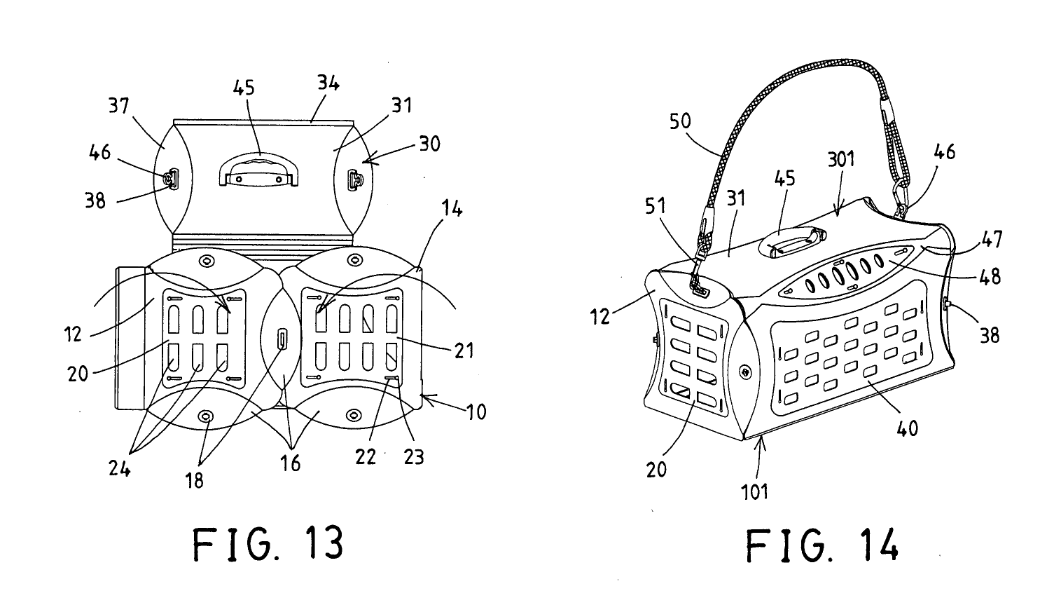

In operation, as shown in FIGS. 10-13, when the upper member 30 and the base member 10 are separated or disengaged from each other, the upper member 30 and the base member 10 may be superposed with each other and may be folded to a compact folding or receiving structure for storing and transportation purposes, and the upper member 30 may be easily and quickly attached or mounted or secured to the base member 10 to form a rectangular and spatial or three-dimensional structure for suitably and comfortably supporting the small animal therein.

Alternatively, as shown in FIG. 14, the upper member 301 and the base member 101 may be formed or shaped to different shapes or configurations or contours, and the upper member 301 may include two or more folded or wrinkled or curved portions 47 formed or provided on the outer peripheral portion thereof and curved relative to the top wall panel 31 for reinforcing purposes, and may include a further window plate 48 for air circulation or ventilation purposes, or for selectively blocking or sealing the air circulation or ventilation openings of the top wall panel 31 or of the upper member 301.

Accordingly, the foldable and portable shelter in accordance with the present invention includes a foldable structure foldable to a compact folding or receiving structure for storing and transportation purposes, and including an increasing strength for resisting an increased weight or load and for preventing the shelter from being collapsed or distorted.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A shelter comprising:
a base member including a bottom wall panel, a rear wall panel foldably coupled to said bottom wall panel with a first folding line, and a front wall panel foldably coupled to said bottom wall panel with a second folding line,
an upper member including a top wall panel and two opposed side wall panels each foldably coupled to said top wall panel with a third folding line, said side wall panels being secured to said bottom wall panel of said base member for forming a three-dimensional structure,
said base member and said upper member including latch members for selectively latching and locking said front wall panel and said rear wall panel of said base member to said top wall panel and said side wall panels of said upper member, and
said base member and said upper member each including a plurality of openings formed therein for air circulation purposes, and each including a plurality of curved portions formed therein for reinforcing purposes.

2. The shelter as claimed in claim 1, wherein said front wall panel and said rear wall panel of said base member each include three curved portions formed therein, and said top wall panel and said side wall panels of said upper member each include two curved portions formed therein for engaging with said curved portions of said base member.

3. The shelter as claimed in claim 2, wherein said base member includes a first latch member provided on each of said curved portions thereof, and said upper member includes a second latch member provided on each of said curved portions thereof for engaging with said first latch member.

4. The shelter as claimed in claim 3, wherein said first latch member is a female latch member, and said second latch member is a male latch member.

5. The shelter as claimed in claim 1, wherein said upper member includes a hand grip provided on said top wall panel.

6. The shelter as claimed in claim 1, wherein said upper member includes two loops, and a carrying strap having two end couplers for selectively engaging with said loops and for detachably attaching said strap to said shelter.

7. The shelter as claimed in claim 1, wherein said base member includes a pad disposed on said bottom wall panel.

8. The shelter as claimed in claim 1, wherein said openings of said base member are formed in said rear wall panel, said base member includes a window plate slidably attached to said rear wall panel, and said window plate includes a plurality of orifices formed therein for selectively aligning with said openings of said rear wall panel.

9. The shelter as claimed in claim 1, wherein said openings of said base member are formed in said front wall panel, said base member includes a window plate slidably attached to said front wall panel, and said window plate includes a plurality of orifices formed therein for selectively aligning with said openings of said front wall panel.

10. The shelter as claimed in claim 1, wherein said openings of said upper member are formed in one of said side wall panels, said upper member includes a window plate slidably attached to said side wall panel, and said window plate includes a plurality of apertures formed therein for selectively aligning with said openings of said side wall panel.

11. The shelter as claimed in claim 1, wherein said openings of said upper member includes a flange laterally extended from each of said side wall panels for engaging with said bottom wall panel of said base member and for securing to said bottom wall panel of said base member.
